(19) United States
(12) Patent Application Publication
(10) Pub. No.: US 2009/0191351 A1
(43) Pub. Date: Jul. 30, 2009

(54) FUEL CELL BIPOLAR PLATE WITH VARIABLE SURFACE PROPERTIES

(75) Inventors: Jon P. Owejan, Honeoye, NY (US); Thomas A. Trabold, Pittsford, NY (US); Thomas W. Tighe, Bloomfield, NY (US); Reena L. Datta, Rochester, NY (US); Gayatri Vyas Dadheech, Rochester Hills, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/020,715

(22) Filed: Jan. 28, 2008

(51) Int. Cl. H01M 8/02; C23C 8/06; H05H 1/24; C23C 4/12; B05D 5/12

(52) U.S. Cl. 427/446; 429/12; 429/34; 427/585; 427/569; 427/115

(57) ABSTRACT

One embodiment of the invention includes a first fuel cell component comprising a first face, a first hydrophilic coating overlying at least a first portion of the first face, and a second less hydrophilic coating overlying at least a second portion of the first face.

### TECHNICAL FIELD

The field to which the disclosure generally relates includes fuel cell bipolar plates.

### BACKGROUND

A fuel cell is an electro-chemical device that includes an anode and a cathode with an electrolyte between the anode and the cathode. The anode receives hydrogen-rich gas or pure hydrogen and the cathode receives an oxidant such as oxygen or air. The hydrogen gas is dissociated in the anode to generate free protons and electrons. The protons pass through the electrolyte to the cathode, where the protons react with the oxygen and the electrons in the cathode to generate water. The electrons from the anode are unable to pass through the electrolyte. Therefore, the electrons are directed through a load to perform work before they are sent to the cathode. The work may be used, for example but not limited to, operating a vehicle.

Several fuel cells are typically combined in a fuel cell stack to generate the desired power. The fuel cell stack includes a series of bipolar plates. The bipolar plates include an anode side and a cathode side for adjacent fuel cells in the stack. Anode gas flow channels are provided on the anode side of the bipolar plates and cathode gas flow channels are provided on the cathode side of the bipolar plates. The bipolar plates may also include flow channels for a cooling fluid.

The bipolar plates are typically made of a conductive material, such as a carbon-composite or metal, so that they conduct the electricity generated by the fuel cells from one cell to the next cell and out of the stack. The bipolar plates may be machined from relatively thin metal substrates or thin metal substrates that may be stamped to provide reactant gas flow fields and coolant fluid flow fields.

As is well understood in the art, most types of fuel cells need to have a certain relative humidity. During operation of the fuel cell, moisture may enter the anode and cathode flow channels due to the reactant gases being humidified or due to water produced at the cathode. As the size of the water droplets increases, the flow channel is closed off, and the reactant gas is diverted to other flow channels because the channels flow in a generally parallel direction between common inlet and outlet manifolds. Because the reactant gas may not flow through a channel that is blocked with water, the reactant gas cannot force the water out of the channel. As more and more flow channels are blocked by water, the electricity produced by the fuel cell decreases. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the cathode side, this increases the parasitic power applied to the air compressor, thereby reducing overall system efficiency. Moreover, there are many reasons not to use the hydrogen fuel as a purge gas, including reduced economy, reduced system efficiency, and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It is known in the art to coat the bipolar plate with a hydrophilic coating to reduce water accumulation.

### SUMMARY OF EXEMPLARY EMBODIMENTS OF THE INVENTION

One embodiment of the invention includes a first fuel cell component comprising a substrate comprising a first face, a first hydrophilic coating overlying at least a first portion of the first face, and a second less hydrophilic coating overlying at least a second portion of the first face.

Other exemplary embodiments of the invention will become apparent from the detailed description provided hereinafter. It should be understood that the detailed description and specific examples, while indicating the exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings.

FIG. 1 illustrates a product including a bipolar plate comprising a hydrophilic coating, according to one embodiment of the invention.

FIG. 2 illustrates a product including a bipolar plate comprising a hydrophilic coating, according to one embodiment of the invention.

FIG. 3 illustrates a product including a bipolar plate comprising a hydrophilic coating and a hydrophobic coating, according to one embodiment of the invention.

FIG. 4 illustrates a product including a bipolar plate comprising a hydrophilic coating, according to one embodiment of the invention.

FIG. 5 illustrates a product including a bipolar plate comprising a hydrophilic coating, according to one embodiment of the invention.

FIG. 6 illustrates a product including a bipolar plate comprising a hydrophilic coating and a hydrophobic coating, according to one embodiment of the invention.

FIG. 7 illustrates a product including a plurality of bipolar plates and a soft goods portion, according to one embodiment of the invention.

FIG. 8 illustrates a fuel cell with a region with hydrophilic SiOₓ coating removed from lands and a region with hydrophilic SiOₓ coating over the lands.

FIG. 9 is a plot illustrating the distribution of liquid water for a bipolar plate with hydrophilic coating on channels and lands, a bipolar plate with hydrophilic coating removed from all lands, and a bipolar plate with hydrophilic coating removed from lands near the inlet and outlet of the flowfield.

### DETAILED DESCRIPTION OF EXEMPLARY EMBODIMENTS

The following description of the embodiments is merely exemplary in nature and is in no way intended to limit the invention, its application, or uses.

One embodiment of the invention includes a bipolar plate having variable surface properties to maximize the beneficial effects of low electrical resistance and low accumulated water mass, wherein the bipolar plate has a super-hydrophilic channel bottom and/or sidewalls, and less hydrophilic (or hydrophobic) lands that maximize product water transport from diffusion media to channels with no added electrical resistance. In another embodiment, a hydrophilic coating is applied so that the gas inlet areas of the fuel cell are more hydrophilic than the center of the cell.

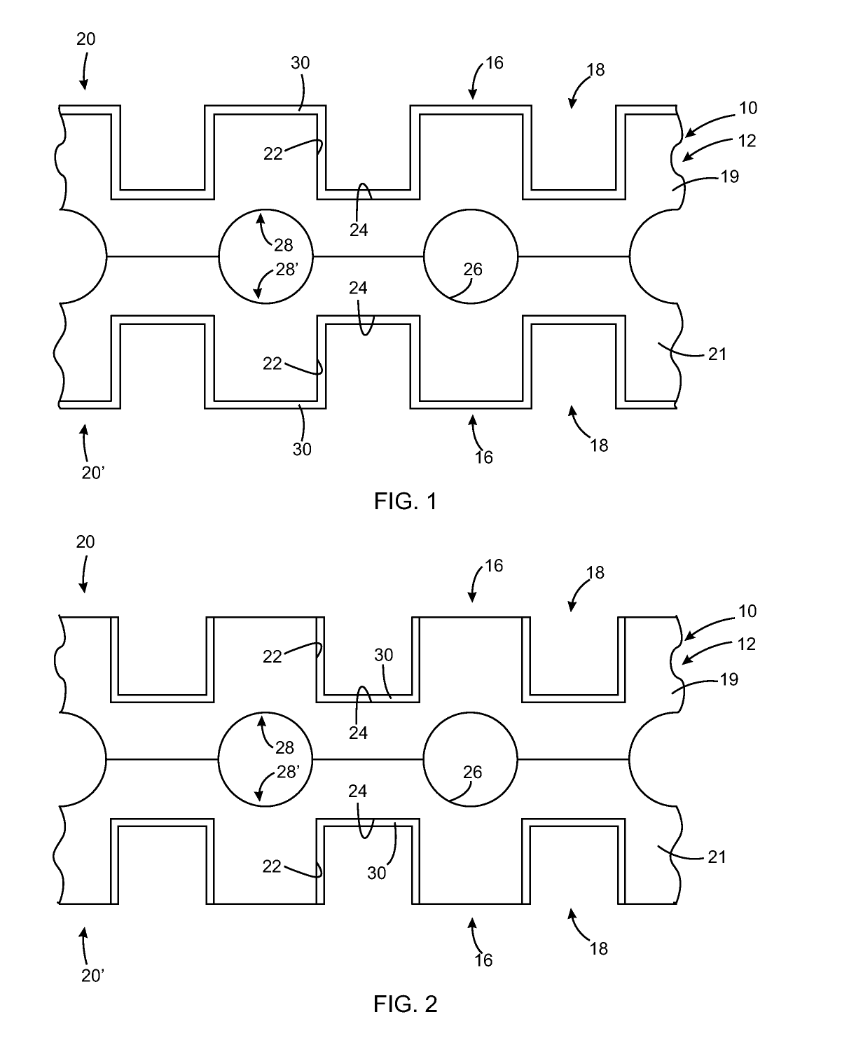

FIG. 1 illustrates one embodiment of a product 10 which may be a bipolar plate 12. The bipolar plate 12 includes a first face 20 and a second face 20′. In one embodiment, the bipolar plate 12 may include two sheets 19 and 21. The two sheets 19 and 21 may be machined or stamped. The two sheets 19 and 21 may be attached to each other for example by welding. The bipolar plate 12 may include a variety of materials including but not limited to a metal, metal alloy and/or electrically conductive composite. The bipolar plate 12 includes reactant gas flow fields defined at least in part by a plurality of lands 16 and channels 18 in the first face 20 and the second face 20′. A channel 18 may be defined by sidewalls 22 and a bottom wall 24. Cooling channels 26 may be provided, for example but not limited to, in the center of the bipolar plate 12. Portions of the cooling channels may be defined by a third face 28 and a fourth face 28′ of the bipolar plate 12. In another embodiment (not shown), the bipolar plate 12 may be a single piece bipolar plate with cooling channel holes drilled through the middle.

A first coating 30 is formed over at least a portion of the bipolar plate 12. The first coating 30 may be formed over the entire surface of the bipolar plate including the lands 16 and channels 18, or the coating 30 may be selectively deposited over portions of the bipolar plate, for example, over only the channels 18. The first coating 30 may be a hydrophilic coating, for example a metal oxide coating including, but not limited to, silicon dioxide (SiO₂), hafnium dioxide (HfO₂), zirconium dioxide (ZrO₂), aluminum oxide (Al₂O₃), stannic oxide (SnO₂), tantalum pent-oxide (Ta₂O₅), niobium pentoxide (Nb₂O₅), molybdenum dioxide (MoO₂), iridium dioxide (IrO₂), ruthenium dioxide (RuO₂), metastable oxynitrides, nonstoichiometric metal oxides, oxynitrides and mixtures thereof, as disclosed in U.S. Patent Application No. 2006/0216571A1. The first coating 30 may be a combination of a conductive material and a metal oxide as disclosed in U.S. Patent Application No. 2006/0194095A1. The first coating 30 may also be a SiOₓ coating. The first coating 30 may be formed by, for example, physical vapor deposition processes, chemical vapor deposition (CVD) processes, plasma enhanced CVD processes, thermal spraying processes, sol-gel, spraying, dipping, brushing, spinning on, or screen printing. The thickness, and consequently the hydrophilicity, of the first coating 30 may be increased by dipping multiple times. The thickness of the first coating 30 may be about 50 nanometers to about 1 micrometer.

Channel water accumulation in both anode and cathode flow field plates may significantly influence fuel cell performance at low load. In various embodiments, the coating 30 is a hydrophilic coating that may reduce or eliminate voltage instability at low load with fine-pitch flow fields, due to the spreading of product water into thin films that have little impact on plate flow resistance. Water transport out of the diffusion media and into the flow field channels may be enhanced, with no increase in electrical resistance. In other embodiments, the coating 30 may reduce the rate of carbon corrosion in the electrodes of a membrane electrode assembly by reducing the formation of full-channel water slugs in the anode channels and accumulation in anode diffusion media that can cause hydrogen starvation. In other embodiments, the coating 30 may reduce freeze damage and freeze start-up time by minimizing the accumulated water mass in the channels and diffusion media.

According to another embodiment of the invention illustrated in FIG. 2, a mask may be selectively deposited over portions of a bipolar plate 12, for example, over the lands 16, leaving the channels 18 exposed. The first coating 30 is selectively formed over only the sidewalls 22 and bottom wall 24 of channels 18. Thereafter the mask is removed. In another embodiment, the first coating 30 may be formed over the entire surface of the bipolar plate including the lands 16 and channels 18, and thereafter the coating may be removed from selective portions of the bipolar plate surface, for example from the lands 16 of the bipolar plate.

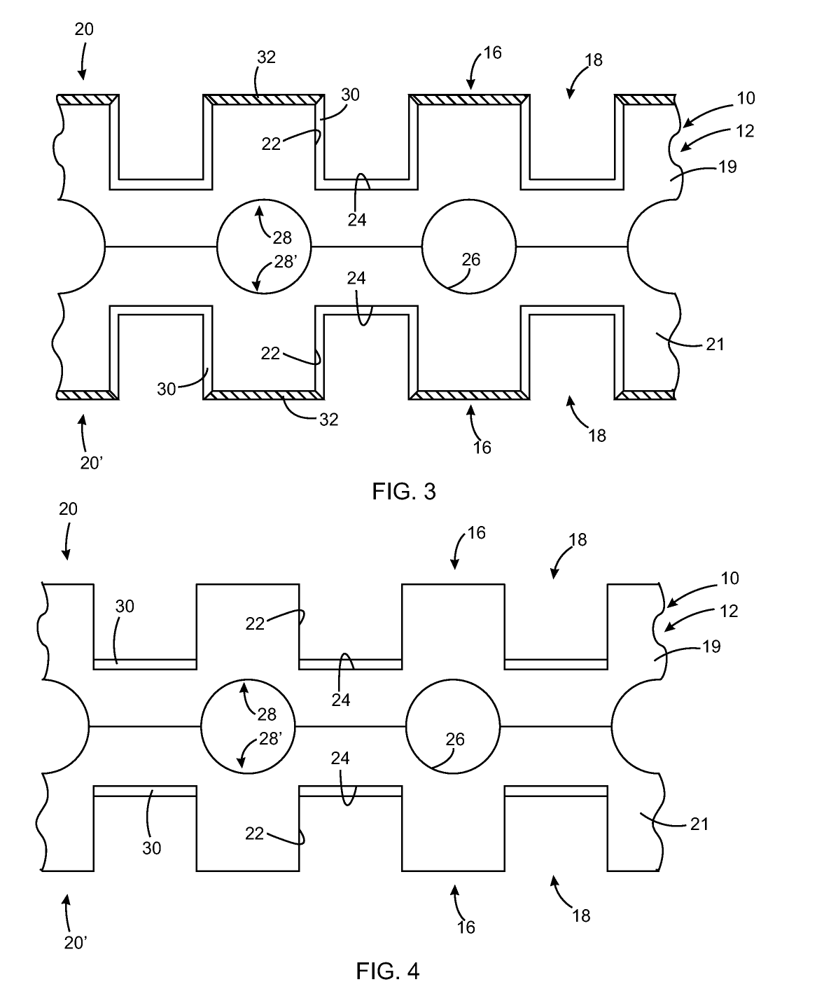

According to one embodiment of the invention illustrated in FIG. 3, a masking material may be selectively deposited over portions of a bipolar plate 12, for example, over the lands 16, leaving the channels 18 exposed. A first coating 30 is selectively formed over only the sidewalls 22 and bottom wall 24 of channels 18. Thereafter the masking material is removed. A second coating 32 comprising a coating that is less hydrophilic than the first coating, and that may be hydrophobic, may be formed over the lands 16 of the bipolar plate. The second coating 32 may be formed by, for example, physical vapor deposition processes, chemical vapor deposition (CVD) processes, plasma enhanced CVD processes, thermal spraying processes, sol-gel, spraying, dipping, brushing, spinning on, or screen printing. The second coating 32 may be PTFE. In another embodiment of the invention, the second coating may be formed prior to the first coating.

According to another embodiment of the invention illustrated in FIG. 4, a mask may be selectively deposited over portions of bipolar plate 12, for example, over the lands 16 and sidewalls 22 of channels 18, leaving the bottom wall 24 of channels 18 exposed. The first coating 30 is selectively formed over only the bottom wall 24 of channels 18. Thereafter the mask is removed from the lands 16 and from the sidewalls 22 of channels 18. In another embodiment, the first coating 30 may be formed over the entire surface of the bipolar plate including the lands 16 and channels 18, and thereafter the first coating may be removed from the lands 16 and the sidewalls 22 of channels 18 of the bipolar plate leaving the first coating over the bottom wall 24 of the channel 18.

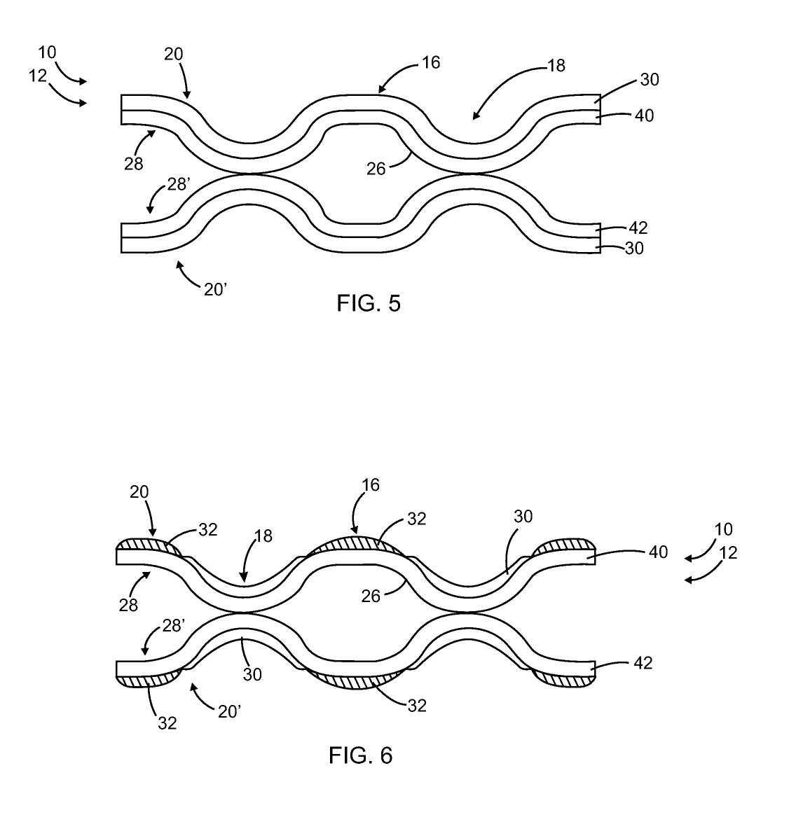

Referring now to FIG. 5, another embodiment of the invention comprises a bipolar plate 12 comprising a first thin metal sheet 40 and a second thin metal sheet 42 which each have been stamped and joined to provide a plurality of lands 16 and channels 18. The cooling channels 26 may be provided between the first metal sheet 40 and the second metal sheet 42. Portions of the cooling channels may be defined by third and fourth faces 28, 28′ of the bipolar plate 12. The first and second faces 20 and 20′ of the bipolar plate 12 may have a first coating 30 formed thereon. The first coating 30 may be formed as described above.

According to another embodiment of the invention illustrated in FIG. 6, a mask may be selectively deposited over portions of bipolar plate 12, for example, over the lands 16, leaving the channels 18 exposed. The first coating 30 is selectively formed over only the channels 18. Thereafter the mask is removed. A second coating 32 comprising a conductive, hydrophobic coating may be formed over the lands 16 of the bipolar plate. In another embodiment, the second coating 32 may be formed prior to the first coating.

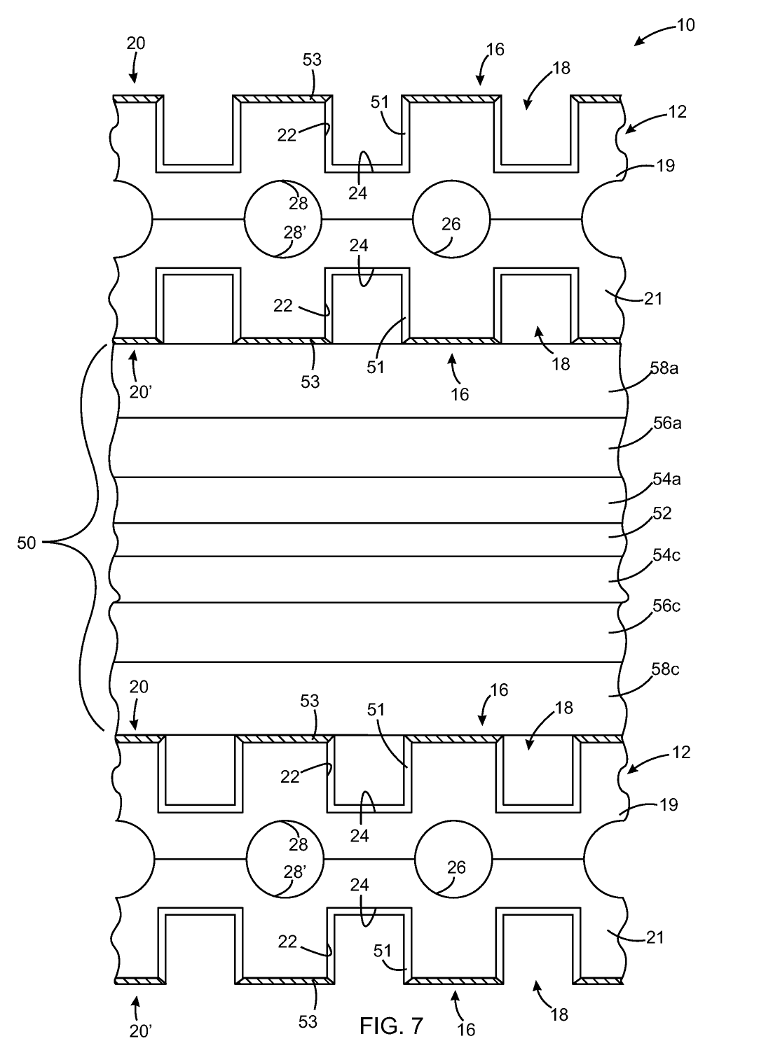

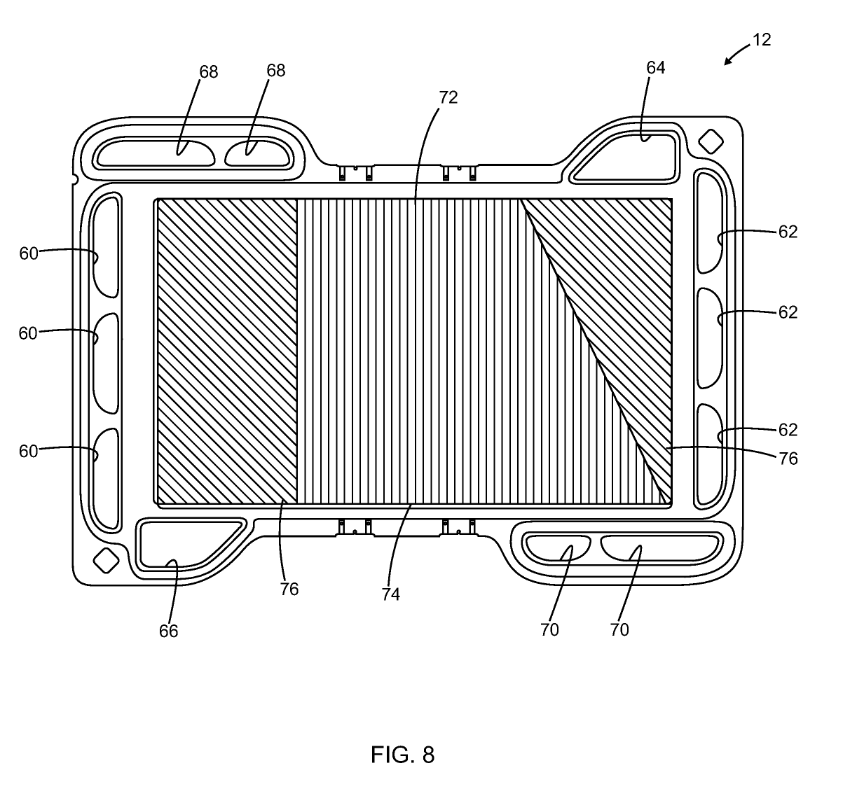

Referring now to FIG. 7, the product 10 includes two spaced apart bipolar plates 12 and a soft goods portion 50 therebetween. The soft goods portion 50 may face the flow fields of the bipolar plates 12, wherein the flow fields comprise the lands 16 and channels 18 of the bipolar plate. The bipolar plates 12 may have a first coating 51 overlying at least a first portion of the bipolar plate, wherein the first portion may be the channels 18. The bipolar plates 12 may have a second coating 53 overlying at least a second portion of the bipolar plate, wherein the second portion may be the lands 16. The soft goods portion 50 may include a polyelectrolyte membrane 52 having a first electrode 54a, such as an anode, overlying the polyelectrolyte membrane 52. A microporous layer 56a may overlie the first electrode 54a, and a first gas diffusion media layer 58a may overlie the first microporous layer 56a. Similarly, a second electrode 54c, such as a cathode, may underlie the polyelectrolyte membrane 52. A second microporous layer 56c may underlie the second electrode 54c and a second gas diffusion media layer 58c may underlie the second microporous layer 56c.

In one embodiment of the invention, the hydrophilic character of the bipolar plate 12 is varied in the active area plane. For example, a hydrophilic coating may be applied such that the gas inlet areas are more hydrophilic than the center of the fuel cell. Referring now to FIG. 8, the bipolar plate 12 is provided with cathode inlets 60, cathode outlets 62, anode inlet 64, anode outlet 66, coolant inlets 68, and coolant outlets 70. The channels in all portions of the active area 72 may have a hydrophilic SiOₓ coating. The active area 72 includes a portion 74 with a hydrophilic SiOₓ coating removed from the lands and a portion 76 with a hydrophilic SiOₓ coating over the lands.

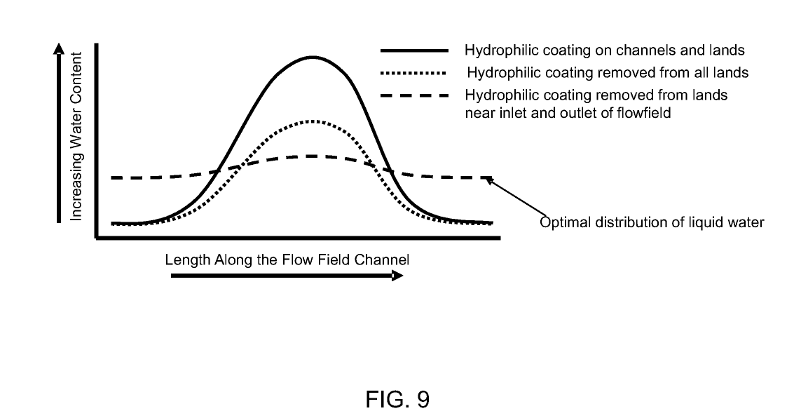

Neutron radiography experiments were performed to show the water distribution in various 50 cm² fuel cells: a fuel cell where the bipolar plate has a SiOₓ hydrophilic coating over both the channels and the lands, a fuel cell where the bipolar plate has a SiOₓ hydrophilic coating over the channels but where the hydrophilic coating has been removed from the lands, and a fuel cell where the bipolar plate has a SiOₓ hydrophilic coating over the channels but where the hydrophilic coating has been removed from the lands near the inlet and the outlet of the flowfield. FIG. 9 is a plot illustrating the results of these experiments. Referring now to FIG. 9, the optimal distribution of liquid water in the fuel cell may be achieved when the hydrophilic coating is removed from lands near the inlet and outlet of the flowfield. FIG. 9 also illustrates that the distribution of liquid water in a fuel cell is better for a bipolar plate with hydrophilic coating over the channels but removed from all lands than for a bipolar plate with hydrophilic coating on both the lands and the channels.

Completely coating the bipolar plate (the lands and the channels) may increase the electrical resistance at the contact areas between the bipolar plates and diffusion media. For example, an SiOₓ coating with a mean thickness of 80 to 100 nanometers added an average resistance of 11.6 mΩ cm², based on a sample of 160 plates and an average untreated plate resistance of 44.0 mΩ cm². Placing the highly hydrophilic PTFE-coated diffusion media against the highly hydrophilic coated bipolar plate lands does not maximize the rejection of product water from the contact region, which may be beneficial for reduced mass transport resistance.

In various embodiments, minimal water accumulation and the best fuel cell performance can be realized with hydrophilic channels and less hydrophilic lands. The overall mass of accumulated water is less for the bipolar plate where the hydrophilic coating has been removed from the cathode lands. In a fuel cell where the channels of the bipolar plate are coated with a SiOₓ hydrophilic coating and the lands are less hydrophilic, the water may be more effectively ejected from the gas diffusion media layer in the lands. While the SiOₓ hydrophilic coating over both the lands and the channels may reduce the total accumulated water mass by 55% as compared to an untreated bipolar plate, the total accumulated water mass may decrease by an additional 13% when the SiOₓ hydrophilic coating is removed from the cathode lands.

When the terms “over”, “overlying”, “overlies”, or “under”, “underlying”, “underlies” are used with respect to the relative position of a first component or layer with respect to a second component or layer, such shall mean that the first component or layer is in direct contact with the second component or layer, or that additional layers or components are interposed between the first component or layer and the second component or layer.

The above description of embodiments of the invention is merely exemplary in nature and, thus, variations thereof are not to be regarded as a departure from the spirit and scope of the invention.

What is claimed is:

1. A product comprising:
a first fuel cell component comprising a first face, a first hydrophilic coating overlying at least a first portion of the first face, and a second less hydrophilic coating overlying at least a second portion of the first face.

2. A product as set forth in claim 1 wherein the second coating is hydrophobic.

3. A product as set forth in claim 1 wherein the second coating comprises PTFE.

4. A product as set forth in claim 1 wherein the first coating has a thickness of about 50 nanometers to about 1 micrometer.

5. A product as set forth in claim 1 wherein the second coating has a thickness of about 50 nanometers to about 1 micrometer.

6. A product as set forth in claim 1 wherein the fuel cell component comprises a bipolar plate.

7. A product as set forth in claim 1 further comprising a reactant gas flow field comprising lands and channels in the first face.

8. A product as set forth in claim 7 wherein the first portion consists essentially of sidewalls and bottom walls of the channels.

9. A product as set forth in claim 7 wherein the first portion consists essentially of the bottom walls of the channels.

10. A product as set forth in claim 7 wherein the second portion comprises the lands.

11. A product as set forth in claim 1 further comprising:
a second fuel cell component comprising a first face, and wherein each of the first fuel cell component and the second fuel cell component comprises a bipolar plate and a reactant gas flow field comprising lands and channels defined in the first face of each bipolar plate; and
a soft goods portion positioned between the bipolar plates and facing the flow fields, wherein the soft goods portion comprises an anode and a cathode on opposite faces of a polymer electrolyte membrane.

12. A product as set forth in claim 11 wherein the first portion of the first face comprises gas inlet areas.

13. A product as set forth in claim 12 wherein the first portion of the first face consists essentially of sidewalls and bottom walls of the channels in the gas inlet areas.

14. A product as set forth in claim 12 wherein the first portion of the first face consists essentially of the bottom walls of the channels in gas inlet areas.

15. A product as set forth in claim 11 wherein the second portion of the first face comprises the center of the first face.

16. A product as set forth in claim 15 wherein the second portion of the first face comprises the lands in the center of the first face.

17. A process for making a fuel cell component comprising:
providing a substrate comprising a first face and a reactant gas flow field defined in the first face;
forming a first hydrophilic coating over at least a first portion of the first face; and
forming a second less hydrophilic coating over at least a second portion of the first face so that the substrate includes a surface with a selectively exposed portion of the first hydrophilic coating and a selectively exposed portion of the second hydrophilic coating.

18. A process as set forth in claim 17 wherein the second less hydrophilic coating is a hydrophobic coating.

19. A process as set forth in claim 17 wherein the forming a first coating comprises at least one of physical vapor deposition processes, chemical vapor deposition (CVD) processes, plasma enhanced CVD processes, thermal spraying processes, sol-gel, spraying, dipping, brushing, spinning on, or screen printing.

20. A process as set forth in claim 17 wherein the forming a second coating comprises at least one of physical vapor deposition processes, chemical vapor deposition (CVD) processes, plasma enhanced CVD processes, thermal spraying processes, sol-gel, spraying, dipping, brushing, spinning on, or screen printing

21. A process as set forth in claim 17 further comprising forming the second coating prior to the first coating.

22. A process for making a fuel cell component comprising:
providing a substrate comprising a first face and a reactant gas flow field defined in the first face;
forming a first hydrophilic coating over the first face; and
removing the first hydrophilic coating from at least a portion of the first face so that the substrate includes a surface with a selectively exposed portion of the first hydrophilic coating.

23. A process as set forth in claim 22 wherein the portion of the first face comprises lands.

24. A process as set forth in claim 23 wherein the portion of the first face comprises lands in the center of the first face.

25. A process for making a fuel cell component comprising:
providing a substrate comprising a first face and a reactant gas flow field defined in the first face;
forming a mask over a first portion of the first face;
forming a first hydrophilic coating over the first face; and
removing the mask so that the substrate includes the hydrophilic coating over a second portion of the first face.
